(19) United States
(12) Patent Application Publication
(10) Pub. No.: US 2021/0178557 A1
(43) Pub. Date: Jun. 17, 2021

(54) Adapter Tool for Jackstand

(71) Applicant: Oneida Business Enterprises Inc., Canastota, NY (US)

(72) Inventor: Paul A. Kocur, Auburn, NY (US)

(21) Appl. No.: 16/710,141

(22) Filed: Dec. 11, 2019

(51) Int. Cl. B25B 13/50; B66F 13/00

(52) U.S. Cl. CPC B25B 13/5008; B60S 9/08; B66F 13/00; B25B 13/5091

(57) ABSTRACT

A jackstand adapter tool attaches onto a square-drive power driver, so that the tool and driver can be used in the field for winding and unwinding the threaded rod of a jackstand. The tool engages the radial lift handles that protrude from the top part of threaded rod. The adapter may be a generally cylindrical member that fits over the top end of the rod (with its top plate removed) with opposed recesses at a lower edge to engage the lift handles.

### BACKGROUND OF THE INVENTION

This invention relates to a tool in the nature of a wrench head, which may be used with a power driver to facilitate working of a jack stand or jack screw. In particular, the invention is directed to an improvement to a power tool attachment, wherein the adapter tool can be fitted onto a rotary power driver, and can reach over an axial projection from a threaded member and down to a transverse bar or pair of transverse or radial lift handles to rotate the threaded member.

A technique for using a power tool to raise and lower the threaded rod of a jack screw has eluded the various trades that install these devices. In the case of disaster recovery, a multitude of these jack screws need to be prepared and installed on emergency shelters and other temporary structures, such as in supporting trailers used in a disaster response for housing persons displaced by events such as hurricane, flood, forest fire, and others. Normally recovery response involves hundreds of these emergency shelters. Four to six jack screws are needed to support the frame of each housing trailer, and each of these has to be extended and lowered for lubricating and preparation, and then placed in position on the trailer frame and raised. These motions are carried out by hand, rotating the cross bars or lift handles of the jack screw to turn the threaded rod over its extent. This work is exhausting to the workers, and is often done in blistering heat in a place without shade or shelter. To date there have been no means available for applying a power tool to these jack screws to facilitate preparation and installation.

### OBJECTS AND SUMMARY OF THE INVENTION

Accordingly, it is an object to provide a tool that can be mounted on a power driver for use in raising and lowering the threaded rod of the jackscrew, so as to avoid the drawbacks mentioned hereinabove.

A more specific object of this invention is to provide an adapter tool that can be fitted to an available square-drive power driver, and can fit over the jackstand threaded rod to reach the lift handles and rotate them in either direction.

Another object is to provide the an adapter tool that will facilitate the work involved in preparing and installing a multitude of jack stands onto trailers or other structures, saving time and human effort.

According to an aspect of the present invention, a jackstand adapter tool is configured for attachment onto a square-drive power driver, so that the tool and driver can be used in the field for winding and unwinding the jackstand, where a male threaded rod is threadably fitted into a female threaded post that is supported on a bottom footing. The tool engages the one or more transverse horizontal rods or lift handles that protrude from the top part of threaded rod. The jackstand adapter comprising a fitting configured to fit over the top end of said threaded rod (with the top plate or cradle removed) and to engage said transverse horizontal rod(s) or lift handles. The fitting has a receptacle, e.g., square socket, formed at an upper end thereof to receive a drive member of a power driver tool.

In a preferred embodiment, the fitting is in the form of a rigid tube, e.g. steel pipe or equivalent, having a plurality of cutouts at a lower open end thereof configured to engage said transverse horizontal rod. In the described embodiment, there are two one-inch cutouts positioned diametrically opposite one another a the bottom edge to engage the two lift handle. Favorably, the rigid tube has an inside diameter of substantially three inches. Favorably also, the rigid tube has an interior diameter of about three inches and with an interior axial height of about three to six inches. The receptacle for the power driver can be in the form of a square aperture of substantially ¾ inch by ¾ inch, and a depth of substantially ½ inch or more, and removably snaps in place onto the square drive plug of the power driver tool.

The jackstand adapter is not limited only to the tubular design, but can have an open design with a top plate and opposite side plates, each with a cutout for the respective lift arm.

The method of preparing the associated jackscrew for installation is carried out by placing a jackstand adapter tool onto a drive plug or other drive member of a hand-held power driver tool; placing the jackstand adapter tool over the top end of the threaded rod such that the jackstand adapter tool engages the one or more transverse horizontal rods of the threaded rod; and then actuating the hand-held power driver tool to rotate alternately both the jackstand adapter tool and the threaded rod with which is engaged so as to raise and lower the jackstand threaded rod with respect to the associated female threaded post.

These and other objects, features, and advantages of the invention will become apparent from the following detailed description of a selected preferred embodiment, which is to be read in connection with the accompanying Drawing:

### BRIEF DESCRIPTION OF THE DRAWING

FIG. 1 is a perspective view of a typical jack stand on which the adapter of this invention may be applied.

FIGS. 2, 3, 4, and 5 are a perspective view, elevation, top plan and bottom plan view, respectively, of an adapter according to an embodiment of this invention.

FIG. 6 is a perspective of jack stand on which the adapter of this embodiment may be employed.

FIG. 7 is an assembly view showing placement of the adapter on the jack stand.

FIG. 8 shows a workman with power driver employing the adapter of this invention.

FIG. 9 is a perspective view of an alternative embodiment of the adapter of this invention.

### DETAILED DESCRIPTION OF THE PREFERRED EMBODIMENT

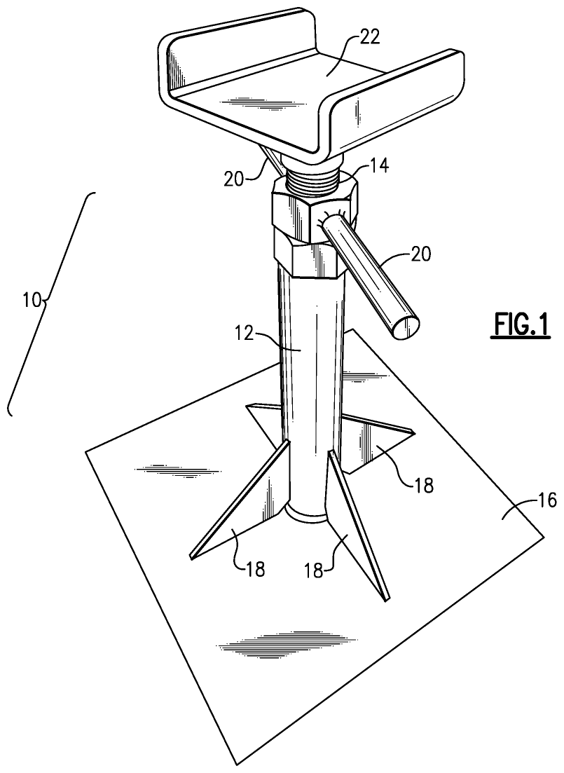

With reference to the Drawing Figures, a jack stand 10 is shown in FIG. 1, as being typical of the type that are used for supporting the frame of a trailer such as a residential trailer as employed for emergency housing following a hurricane, forest fire, or other event in which numerous people are displaced from their homes. The jack stand 10 has a vertical female-threaded post 12 with a male-threaded rod 14 engaged in its threads. The post 12 is supported on a base 16, here shown as having support gussets 18 that distribute the weight of the supported structure onto the base 16. A pair of lift handles 20 extend out horizontally from near the top of the rod 14. Conventionally, these are rotated, by hand, to raise or lower the threaded rod 14. A steel top plate or support cradle 22 is removably positioned at the top of the threaded rod, and this member serves to engage a beam or other support member of the frame of the supported trailer.

Normally, in a disaster response operation, there are four to six of these jack stands employed for supporting each trailer, and there may be a hundred or more trailers involved on which jack stands need to be installed. Prior to installation, each jack stand 10 needs to be prepared by lubricating it and raising and lowering the threaded rod several times. This is traditionally done by hand, and when done in the field this is often done in extreme weather and is an exhausting operation for those involved in installing the jack stands. To date, there has been no technique proposed for employing a power driver to raise and lower these jack stands.

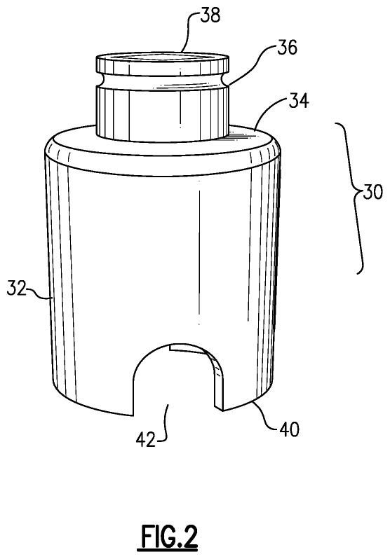

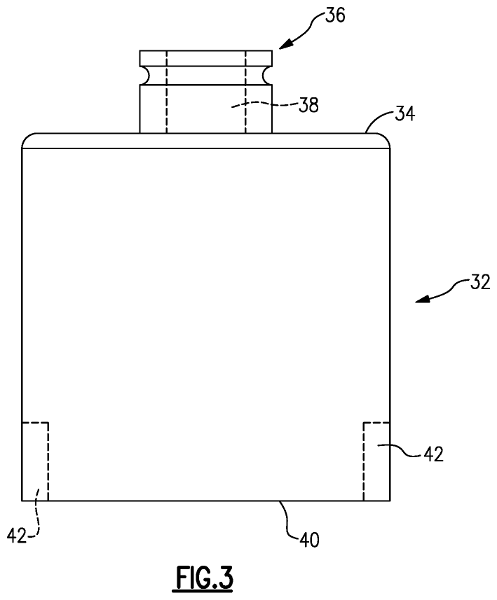

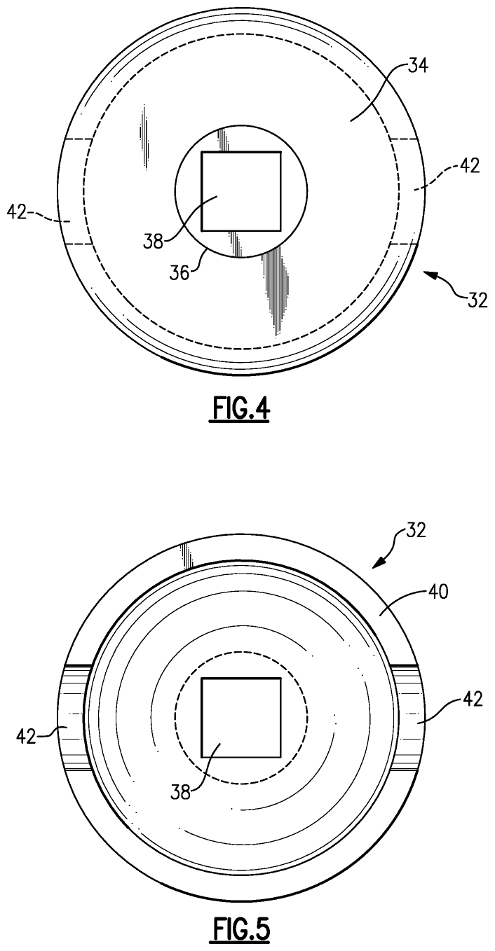

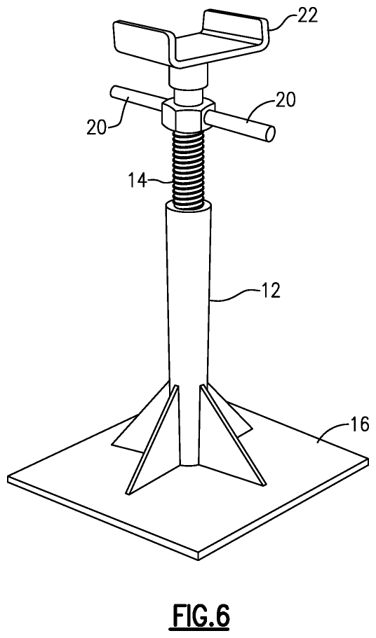

In one preferred embodiment, as shown with reference to FIG. 2, as well as the elevation of FIG. 3 and further reference to plan views of FIGS. 4 and 5, the adapter 30 is configured to allow use of a power driver to connect, over the top of the threaded rod 14 to the two lift handles 20 and rapidly rotate the rod 14 in both directions to raise and lower it. The adapter is configured a socket drive head tool with a body 32 in the form of a steel tubular steel cylidrical member, here with an internal diameter of about three inches and a depth of about six inches, a closed top 34, and a socket member 36 formed at the center of the top 34. The socket member here has a square center aperture 38 that is ¾ inches by ¾ inches to one inch by one inch, so as to accommodate available square-drive power drivers. The adapter tool 30 has an open, circular bottom edge 40, with cutouts 42 disposed at intervals around the bottom edge. Here there are two cutouts at 180 degree intervals. These cutouts are favorably about one inch across and approximately that height, with a rounded top portion, as shown.

FIGS. 3, 4 and 5 illustrate details of this particular embodiment. With FIG. 3 being an elevation, and FIGS. 4 and 5 being top and bottom plan views, respectively. These show the placement of the drive socket 36 and lift-handle recesses or cutouts 42 in this one illustrated embodiment.

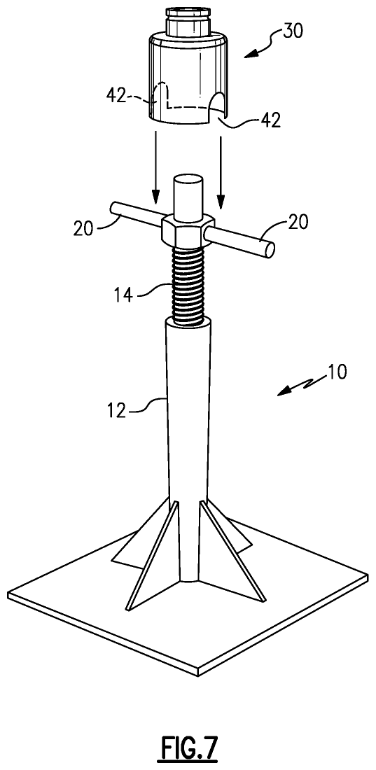

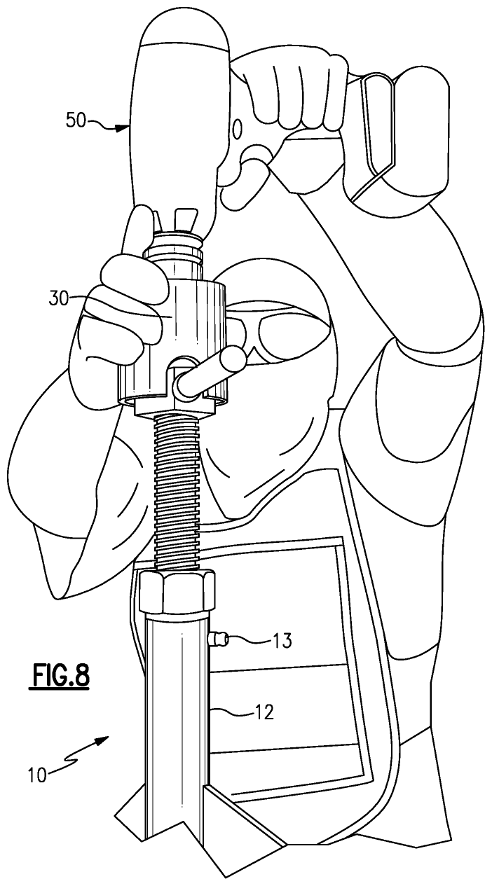

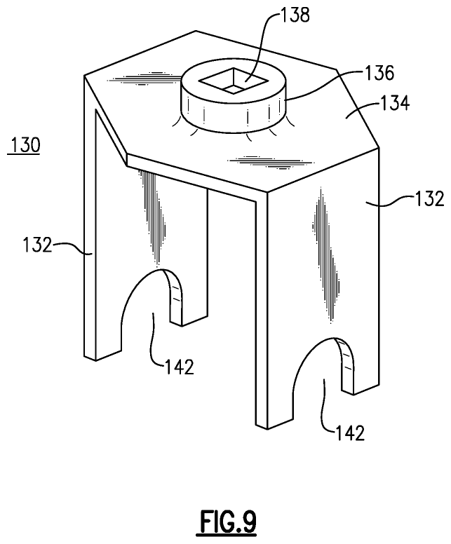

Each jack screw or jack stand 10 in turn is placed erect on its base 16 as shown in FIG. 6, and a lubricant may be injected via a grease fitting 13 (see FIG. 8) on the main post 12. Then, the top plate or cradle 22 is removed. This allow the adapter tool 30 to be positioned over the top end of the threaded rod 14, and with the cutouts 42 engaging the transverse lift handles 20, as shown in FIG. 7. (The adapter tool would be installed on the square drive plug of a power driver 50, although for the sake of simplicity that is not shown in FIG. 7.) A workman can then operate the power driver, as illustrated in FIG. 8, to raise and lower the threaded rod one or several times to prepare the jack screw for installation. Prior to installation the top or cradle 22 is replace on the upper end of the threaded rod 14.

One possible alternative embodiment is illustrated in FIG. 9 as adapter 130, which is of open design which relieves some to much of the weight of the tool. Here the adapter has a top plate 134 of hexagonal shape, with two oppositely positioned horizontal side plates 132, 132, each with a recess 142 or cutout formed midways along its lower edge. A socket member 136 with a square drive aperture 130 is centered at the top of the top plate 134. Many other arrangements are also possible with variants of the jack screw adapter of the present invention.

The above described embodiments are configured for use with a square-drive power driver, as that equipment is widely available. However, the drive sockets used in adapter tools of this invention need not be limited only to those with square drive apertures, as many other configurations may be equivalent.

While the present invention has been described with reference to specific preferred embodiment(s), it should be understood that the invention is not limited to such precise embodiment(s). Rather, many modifications and variations would present themselves to persons skilled in the art without departure from the scope and spirit of this invention, as defined in the appended claims.

What is claimed is:

1. A jackstand adapter for winding and unwinding a jackstand of the type in which a male threaded rod is threadably fitted into a female threaded post that is supported on a bottom footing, and in which a transverse horizontal rod protrudes from the threaded rod at or near a top end thereof; the jackstand adapter comprising a fitting configured to fit over the top end of said threaded rod and engage said transverse horizontal rod, and said fitting having a receptacle formed at an upper end thereof to receive a drive member of a power driver tool.

2. The jackstand adapter of claim 1, wherein said fitting is in the form of a rigid tube having a plurality of cutouts at a lower open end thereof configured to engage said transverse horizontal rod.

3. The jackstand adapter of claim 2 wherein the receptacle on said fitting includes a square socket adapted to receive a square drive plug of said power driver tool.

4. The jackstand adapter of claim 3 wherein said rigid tube has an inside diameter of substantially three inches.

5. The jackstand adapter of claim 2 wherein said plurality of cutouts includes a pair of cutouts disposed diametrically opposite one another at said lower open end, and each having a diameter of substantially one inch.

6. The jackstand adapter of claim 2 wherein said receptacle is in the form of a square aperture of substantially ¾ inch by ¾ inch, and a depth of substantially ½ inch.

7. The jackstand adapter of claim 1 wherein said fitting is in the form of a steel cylindrical tube.

8. A method of preparing a jackstand for installation by winding and unwinding a jackstand, the latter being of the type in which a male threaded rod is threadably fitted into a female threaded post that is supported on a bottom footing, and in which one or more transverse horizontal rods protrudes from the threaded rod at or near a top end thereof; the method comprising
a. placing a jackstand adapter tool onto a drive member of a hand-held power driver tool;
b. placing the jackstand adapter tool over the top end of the threaded rod such that the jackstand adapter tool engages the one or more transverse horizontal rods of the threaded rod; and
c. actuating said hand-held power driver tool to rotate said jackstand adapter tool and the threaded rod with which is engaged alternately so as to raise and lower the jackstand threaded rod with respect to the associated female threaded post; and
wherein the jackstand adapter tool comprises a fitting configured to fit over the top end of said threaded rod and engage said one or more transverse horizontal rods, and said fitting having a receptacle formed at an upper end thereof to receive a drive member of said power driver tool.

9. The method of preparing a jackstand according to claim 8, wherein said fitting is in the form of a rigid tube having a plurality of cutouts at a lower open end thereof configured to engage said one or more transverse horizontal rods.

10. The method of preparing a jackstand according to claim 9 wherein the receptacle on said fitting includes a square socket adapted to receive a square drive plug of said power driver tool.

11. The method of preparing a jackstand according to claim 9 wherein said rigid tube has an inside diameter of substantially three inches.

12. The method of preparing a jackstand according to claim 9 wherein said plurality of cutouts includes a pair of cutouts disposed diametrically opposite one another at said lower open end, and each having a diameter of substantially one inch.

13. The method of preparing a jackstand according to claim 8 wherein said receptacle is in the form of a socket with a square aperture of substantially ¾ inch by ¾ inch.
